(19) United States
(12) Patent Application Publication
(10) Pub. No.: US 2023/0019717 A1
(43) Pub. Date: Jan. 19, 2023

(54) COLLAPSIBLE BRIDGE NET

(71) Applicant: Yunior Dominguez, Hialeah, FL (US)

(72) Inventor: Yunior Dominguez, Hialeah, FL (US)

(21) Appl. No.: 17/379,933

(22) Filed: Jul. 19, 2021

(51) Int. Cl. A01K 73/12; A01K 75/00

(52) U.S. Cl. CPC A01K 73/12; A01K 75/00

(57) ABSTRACT

The present invention is a collapsible bridge net having a comprising bottom ring or hoop with netting to form a base; vertical netting that is connected to the bottom ring and extending to a larger top ring, which is formed by the connection of one or more rods by a fastening means. The rod(s) have loops permanently attached positions equidistant from each other when the top larger ring is formed, and these loops accommodate 4 supporting ropes. The supporting ropes are connected together by a carabiner which also connects the ropes to a draw rope used for lowering the bridge net into the water and then raising it up out of the water with the catch load. The rod(s) may be disconnected to facilitate the folding of the bridge net for storage and ease of transport, hence the collapsible feature.

### STATEMENT REGARDING FEDERALLY SPONSORED RESEARCH OR DEVELOPMENT

This invention has been created without the sponsorship or funding of any federally sponsored research or development program.

### FIELD OF INVENTION

The present invention relates generally to fishing nets and in particular to collapsible fishing nets for easy storage and transport.

### BACKGROUND

In the fishing industry, whether for sport or for profit, fishing nets are used to capture bait, small fish, sea creatures or bigger fish such as marlin, tuna, tarpon or similar fish. Fishing nets used by fishermen come in varying forms, sizes, and shapes, but invariable are too cumbersome to store and transport. Fishing can be done with a line or nets from rivers, piers, boats, or bridges. Fishing for bait or large fish in volume from a bridge requires tremendous strength from the fisherman as well as from the net or fishing apparatus used to haul or pull up a load of fish from that height. The size of the nets or fishing apparatus used from a bridge to haul in or pull up a large load of fish can be cumbersome to transport and store. The net or the fishing apparatus needs to be sturdy and able to withstand the rigors of being cast into the ocean from the varying heights of bridges, being dragged through water, holding the weight of the catch load, and being pulled up quite a distance to the bridge.

The present invention addresses these issues by providing a collapsible bridge net that is strong and sturdy enough to endure the rigors of fishing from a bridge, and is collapsible for ease of transport and storage. The essential feature of this invention allows for the collapsing of the bridge net, making what would otherwise be cumbersome now compact and easy to store and carry.

### SUMMARY OF THE INVENTION

The present invention serves to improve upon existing nets or fishing apparatus and address the storage and transport challenges facing the industry, in particular when fishing from a bridge, without sacrificing the strength and rigidity the net.

The present invention is a bridge net apparatus that is configured as a basket or enclosure that is open at the top portion, and closed at the bottom portion. The bridge net apparatus is comprised of one or more rod(s), which when assembled form one complete ring or oval shaped ring that maintains the shape and integrity of the top portion of the apparatus. Netting is affixed or mounted to the ring created by the rod(s) which connect seamlessly by a removable fastening means. The netting is also attached at the bottom portion to a ring or hoop that is smaller in diameter than the ring created by the rod(s) at the top portion. The entire assembly maintains its integrity during use, transport, or storage. It is the rod(s) at the top portion of the apparatus that is/are separated and allows the apparatus to collapse and fold unto itself for ease of storage and transport. The bridge net apparatus includes four stabilizing ropes, which are positioned equidistant about the circumference of the ring created at the top portion, and are secured to the ring via four (4) loops positioned equidistant about the circumference of the ring created at the top portion of the apparatus. The four stabilizing ropes are connected together by a fastening means which allows for the addition of a draw rope that is used to lower the bridge net into the water and pull it up out of the water with the catch load.

### BRIEF DESCRIPTION OF THE DRAWINGS

The accompanying drawings incorporated in and forming a part of the specification, illustrate several aspects of the present invention, and together with the description serve to explain the principles of the invention. In describing the invention, reference will at times be made to the accompanying drawings in which:

FIG. 1 is a perspective view of the assembled bridge net;

FIG. 2 is a front perspective view of two rods separated to illustrate the collapsible feature of the present invention;

FIG. 3 is a top perspective view of the bridge net in its relaxed state before separating the rod(s);

FIG. 4 is a magnified view of the bridge net shown in FIG. 1;

FIG. 5 is another top perspective view of the bridge net of FIG. 1; and

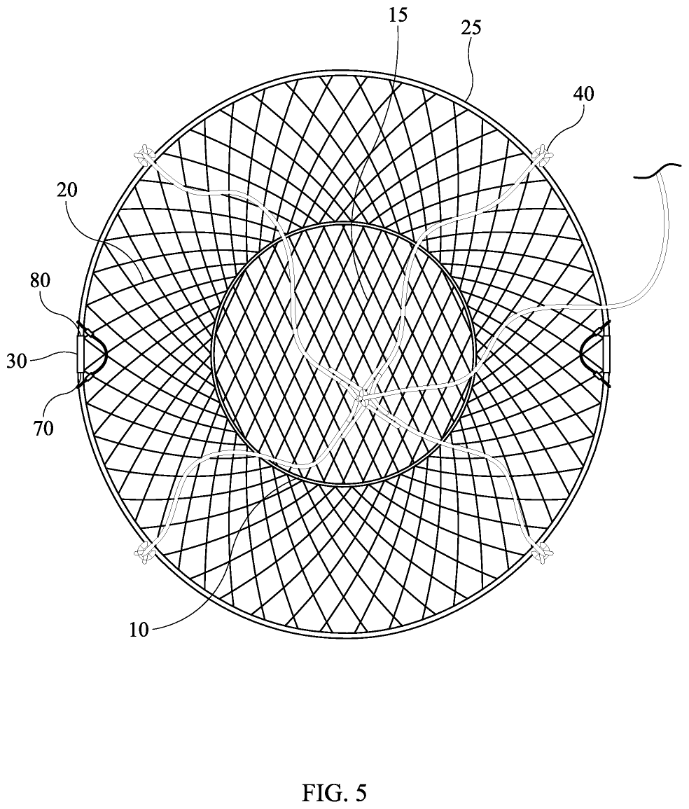

FIG. 6 is a view of the present invention in its collapsed state.

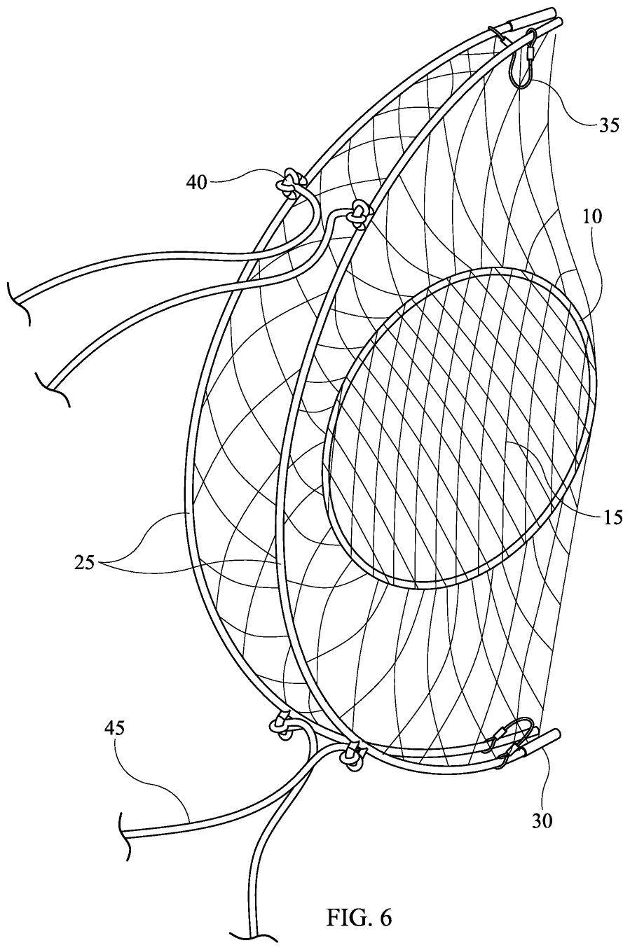

### DESCRIPTION OF THE INVENTION

Before the subject invention is described further, it is to be understood that the invention is not limited to the particular embodiments of the invention described below, as variations of the particular embodiments may be made and still fall within the scope of the invention. It is also to be understood that the terminology employed is for the purpose of describing particular embodiments and is not intended to be limiting.

The details of one or more embodiments of the invention are set forth in the accompanying drawings and the description below. Other features, objects, and advantages of the invention will be apparent from the description and drawings, and from the claims. In the following description, numerous specific details are set forth to provide a thorough understanding of the embodiments. One skilled in the art to which this invention belongs will recognize, however, that the techniques described can be practiced without one or more of the specific details, or with other methods, components, materials, etc. In other instances, well known structures, materials or operations are not shown or described in detail to avoid obscuring certain aspects.

In this specification, the singular forms “a,” “an” and “the” include plural reference unless the context clearly dictates otherwise. Unless defined otherwise, all technical and scientific terms used herein have the same meaning as commonly understood to one of ordinary skill in the art to which this invention belongs.

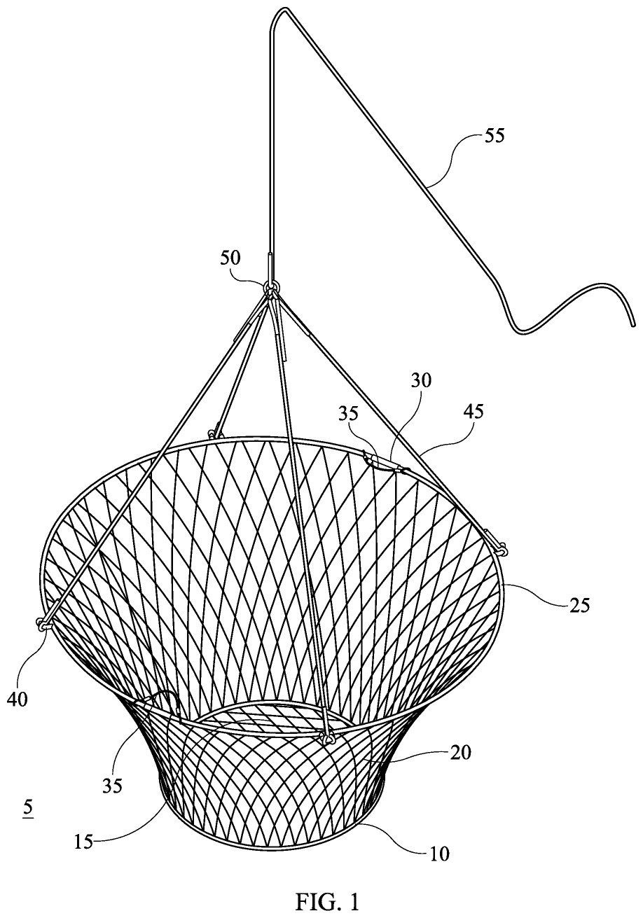

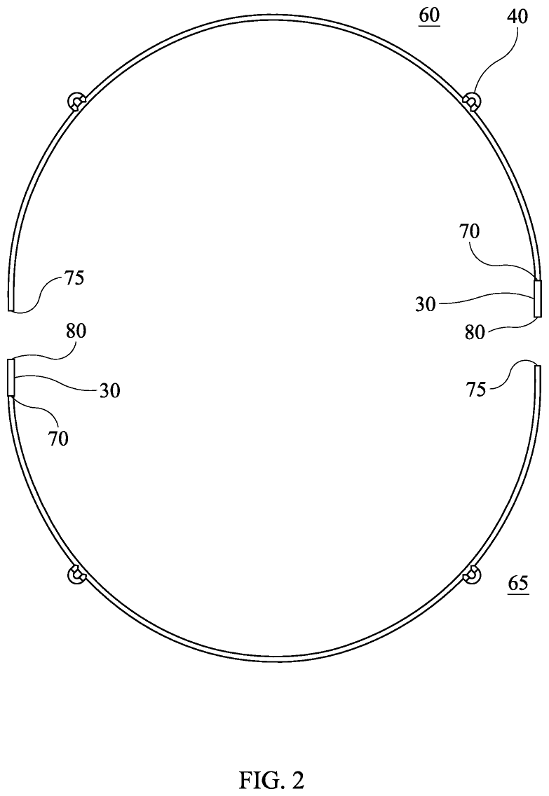

The present invention is a collapsible bridge net 5, as shown in FIG. 1. Fully assembled, the bridge net apparatus resembles a basket with the bottom portion enclosed and the top portion opened. At the bottom portion is a solid bottom ring 10 with horizontal netting 15 affixed about the ring to create an enclosed base, and vertical netting 20 affixed or mounted to the solid bottom ring 10, extending to the top portion to create a wall of netting. At the top portion, the vertical netting 20 is affixed to a larger top ring 25 created by connecting one or more solid rod(s). The embodiment illustrated in FIG. 1 comprises two solid rods, as shown in more detail in FIG. 2. Each rod 60, 65 forms a semi-circle with solid closed ends 75. The rods 60, 65 are fastened together by a hollow cylindrical fastening means 30 that is permanently connected to one end of the rod 70, while the other end of the rod 75 is free of any attachment. Thus, each rod 60, 65 has one closed end 75 and a second end 70 permanently connected to a fastening means 30 with a hollow end 80. The solid closed end 75 of each rod 60, 65 is inserted into the hollow open end 80 of the fastening means 30 at the corresponding end of each rod 60, 65 to securely connect the rods together to form the circular or oval shaped ring at the top portion of the bridge net 5. The secure fit of the rods 60, 65 is achieved by way of the hollow end 80 of the fastening means 30 having a diameter and/or circumference that is slightly larger than the closed end 75 of the rods 60, 65. The connection of the rods 60, 65 may be separated or disconnected by pulling the closed end 75 of the rod 60, 65 out of the hollow open end 80 of the fastening means 30, which facilitates the collapsing of the bridge net 5 for ease of storage and transport.

As shown in FIG. 1 and FIG. 2, each rod 60, 65 includes two loops 40 that are permanently affixed at a position equidistant to each other when the rods 60, 65 are joined at their corresponding ends 70, 75 to form the larger top ring 25 at the top portion of the bridge net 5. The loops 40 are designed to accommodate four stabilizing or supporting ropes 45 that extend from the loops 40 on the larger top ring 25, which ropes 45 are connected together above the basket of the bridge net 5 by a fastening means 50 such as a carabiner, which also allows for connection to a draw rope 55 which is used to lower the bridge net 5 from a bridge down into the water and then raise the bridge net 5 from the water up to the bridge with a full load.

As shown in FIG. 1, the netting 15, 20 are woven about the bottom ring 10 for a secure connection sufficient to handle to weight of the catch. The netting 20 is also woven about the rods 60, 65 that join together to form the larger top ring 25. At the point of connection for each rod 60, 65, spanning the length of the fastener, is a netting stop means 35 for preventing the netting from sliding off the rods 60, 65 when they are separated or disconnected. This netting stop means 35 serves a useful function by eliminating the need to remount or re-affix the netting onto the rods 60, 65 each time the rods 60, 65 are separated or disconnected.

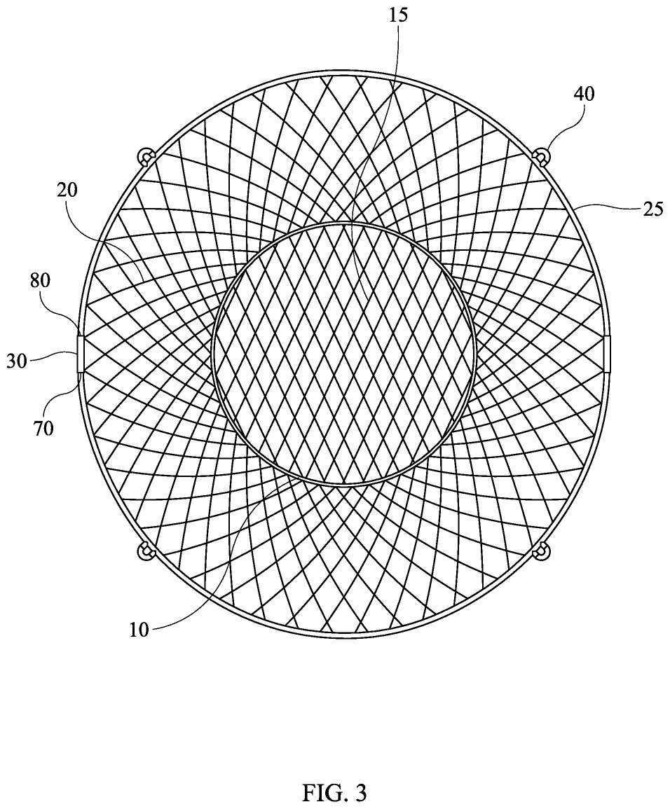

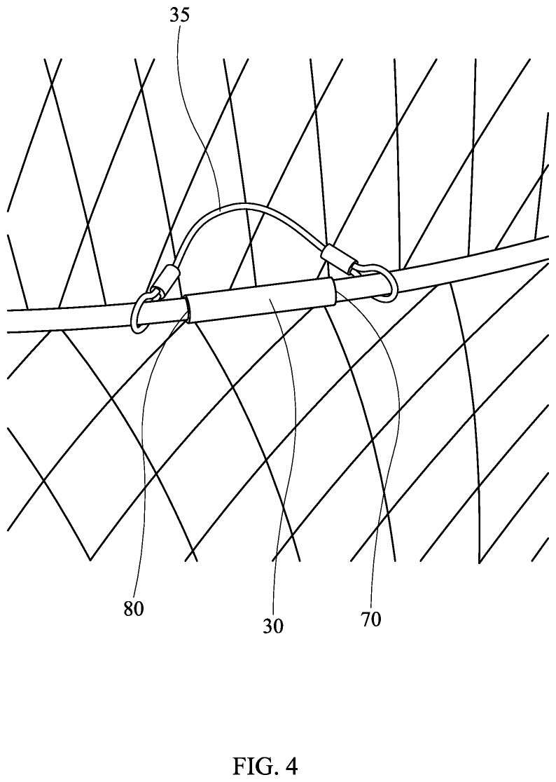

As shown in FIG. 3, when the bridge net 5 is not in use, the netting is relaxed in the area between the larger top ring 25 and bottom ring 10. As shown in FIG. 4, when the rods 60, 65 of the larger top ring 25 are disconnected, they are folded onto each other with the bottom ring 10 positioned in the center, making the apparatus more compact for storage in a carrying case or discreet location. When it is time for use, the apparatus 5 is assembled by unfolding the rods 60, 65 and connecting the fastening means 30 to the corresponding ends 75, 80 of the rods 60, 65.

In this embodiment of the present invention, the bottom ring 10 and the rods 60, 65 of the larger top ring 25 are made of aluminum, but in other embodiments they may be made of stainless steel, steel, metal alloy, fiber glass, durable plastic, or other similar material known to one of ordinary skill in the art to which this invention belongs.

In the embodiments of the invention described herein, the net or netting 15, 20 may comprise of/4 inch or larger single or double braided rope made of natural fibers such as hemp, sisal, cotton, flax, or jute, which list is not meant to be exclusive or exhaustive. In the embodiments of the invention described herein, the net or netting 15, 20 may comprise of/4 inch or larger single or double braided rope made of or synthetic fibers such as nylon, polyester, polypropylene or the like, which list is not meant to be exclusive or exhaustive. In the embodiments of the invention described herein, the net or netting 15, 20 may comprise of ¼ inch or larger twisted rope made of natural fibers or synthetic fibers. The stabilizing ropes 45 and the draw rope 55 are thicker than the netting. The supporting ropes 45 and the draw ropes 55 may be made of single or double braided rope with cordage of a diameter of at least 0.5 inches. The stabilizing ropes and the draw rope require higher cordage than the netting because they provide the pulley mechanism for lowering the bridge net 5 into water and raising it out of water over a considerable distance. The disclosed materials and dimensions of the components of the supporting ropes 45 and the draw rope are not meant to be limiting, and may be adjusted for optimal function by one of ordinary skill in the art to which this invention belongs.

In the embodiments of the invention described herein, the loops 40 and fastening means 30 are made of aluminum, however they may be made of other strong non-corrosive metal, stainless steel, metal alloy, or durable plastics known to one of ordinary skill in the art to which this invention belongs. The fastening means 30 may be made of grade 316 stainless steel which is the standard molybdenum-bearing grade that provides better overall corrosion resistant properties than other grades of stainless steel.

The netting stop means 35 may be made of nylon, microfilament, or synthetic polymers known to one of ordinary skill in the art to which this invention belongs.

As various changes may be made in the above-described subject matter without departing from the scope and the spirit of the invention, it is intended that all subject matter contained in the above description, or shown in the accompanying drawings, will be interpreted as descriptive and illustrative, and not in a limiting sense. Many modifications and variations of the present invention are possible in light of the above teachings. It is therefore to be understood that within the scope of the appended claims, the invention may be practiced otherwise than as specifically described.

### EQUIVALENTS

Those skilled in the art will recognize or be able to ascertain using no more than routine experimentation, many equivalents to the specific embodiments of the invention described herein. Such equivalents are intended to be encompassed by the claims.

What is claimed is:

1. A collapsible bridge net comprising:
a. a bottom ring with netting attached to the ring to create a base;
b. a larger top ring comprised of two rods joined together by a fastening means, which rods form semi-circles that are permanently connected each at one end to the fastening means, and removably connected each at the other end to the fastening means;
c. a second netting attached to the lower ring and extending vertically to the larger top ring to form an enclosure;
d. a netting stop means attached to the larger top ring position about the length of the fastening means to prevent the net from moving upon disconnecting the two rods;
e. four loops permanently attached to the two rods in positions that are equidistant when the rods join to form the larger top ring;
f. four supporting ropes that are attached via the loops which extend at a length above the center of the larger top ring, and said ropes are connected to each by a fastening means; and
g. a draw rope that is attached to the four supporting ropes via the same fastening means that joins the supporting ropes together, and the draw rope is used to lower the bridge net apparatus into water and raise it up out of water.
